(19) United States
(12) Patent Application Publication
(10) Pub. No.: US 2010/0045857 A1
(43) Pub. Date: Feb. 25, 2010

(54) Image Processor and Image Processing Method

(75) Inventor: Tadayoshi Kimura, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/475,254

(22) Filed: May 29, 2009

(30) Foreign Application Priority Data
Aug. 22, 2008 (JP) 2008-214303

(51) Int. Cl. H04N 7/01

(52) U.S. Cl. 348/441; 348/E07.003

(57) ABSTRACT

According to one embodiment, an image processor includes a super-resolution converter configured to perform, on receipt of a first video signal with first resolution, super resolution conversion on the first video signal to restore a second video signal with second resolution that is higher than the first resolution by estimating an original pixel value from the first video signal and increasing pixels; a graphics signal generator configured to generate a graphics signal of a predetermined image; and a blend processor provided at later stage of the super-resolution converter, and configured to superimpose the graphics signal on the second video signal.

### CROSS-REFERENCE TO RELATED APPLICATIONS

This application is based upon and claims the benefit of priority from Japanese Patent Application No. 2008-214303, filed Aug. 22, 2008, the entire contents of which are incorporated herein by reference.

### BACKGROUND

1. Field

One embodiment of the invention relates to an image processor and an image processing method.

2. Description of the Related Art

Conventionally, an image display apparatus such as a television superimposes graphics signals used to display a user interface screen, text, and the like, on video signals. Accordingly, the image display apparatus displays an image of the video signals with an image of the graphics signals overlaid thereon. For example, Japanese Patent Application Publication (KOKAI) No. 2005-99516 discloses an image display apparatus that mixes video signals with a graphics image generated by an external graphics generator, and outputs signals corresponding to the mixture image to a display.

According to wide spread of a television and a display with high resolution, resolution of video signals has been further enhanced. In particular, image processing referred to as super resolution conversion which increases resolution of video signals while maintaining sharpness thereof is recently making appearance (for example, see Japanese Patent Application Publication (KOKAI) Nos. 2007-336239 and 2007-310837). Here, the super resolution conversion increases pixels by estimating an original pixel value from a video signal with low resolution, and reproduces a video signal with high resolution.

However, when the super resolution conversion is performed on the video signal on which the graphics signal is superimposed, an image corresponding to the graphics signal might be distorted due to the increase in the resolution during the super resolution conversion. Accordingly, quality of video (image quality) may decrease. The aforementioned technology disclosed in Japanese Patent Application Publication (KOKAI) No. 2005-99516 may be able to superimpose the graphics signal on the video signal; however, the super resolution conversion is not taken into account by the technology. Therefore, such technology cannot prevent the decrease in the quality of video.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of an image display apparatus according to an embodiment of the invention;

FIG. 2 is an exemplary block diagram of a detailed configuration of a resolution increasing module illustrated in FIG. 1;

FIG. 3 is an exemplary sequence diagram of a resolution increase processing of the resolution increasing module illustrated in FIG. 2;

FIG. 4 is an exemplary block diagram of a first modification of the resolution increasing module illustrated in FIG. 2; and

FIG. 5 is an exemplary block diagram of a second modification of the resolution increasing module illustrated in FIG. 2.

### DETAILED DESCRIPTION

Various embodiments according to the invention will be described hereinafter with reference to the accompanying drawings. In general, according to one embodiment of the invention, an image processor includes a super-resolution converter, a graphics signal generator, and a blend processor. The super-resolution converter is configured to perform, on receipt of a first video signal with first resolution, super resolution conversion on the first video signal to restore a second video signal with second resolution that is higher than the first resolution by estimating an original pixel value from the first video signal and increasing pixels. The graphics signal generator is configured to generate a graphics signal of a predetermined image. The blend processor is provided at later stage of the super-resolution converter, and configured to superimpose the graphics signal on the second video signal.

According to another embodiment of the invention, an image processor includes a super-resolution converter, a graphics signal generator, and a blend processor. The super-resolution converter configured to perform super resolution conversion on a first video signal with first resolution to obtain a second video signal with second resolution that is higher than the first resolution using super resolution technology. The graphics signal generator configured to generate a graphics signal of a predetermined image. The blend processor provided at later stage of the super-resolution converter, and configured to superimpose the graphics signal on the second video signal.

According to still another embodiment of the invention, an image processing method includes performing, on receipt of a first video signal with first resolution, super resolution conversion on the first video signal to restore a second video signal with second resolution that is higher than the first resolution by estimating an original pixel value from the first video signal and increasing pixels; generating a graphics signal of a predetermined image; and superimposing the graphics signal on the second video signal.

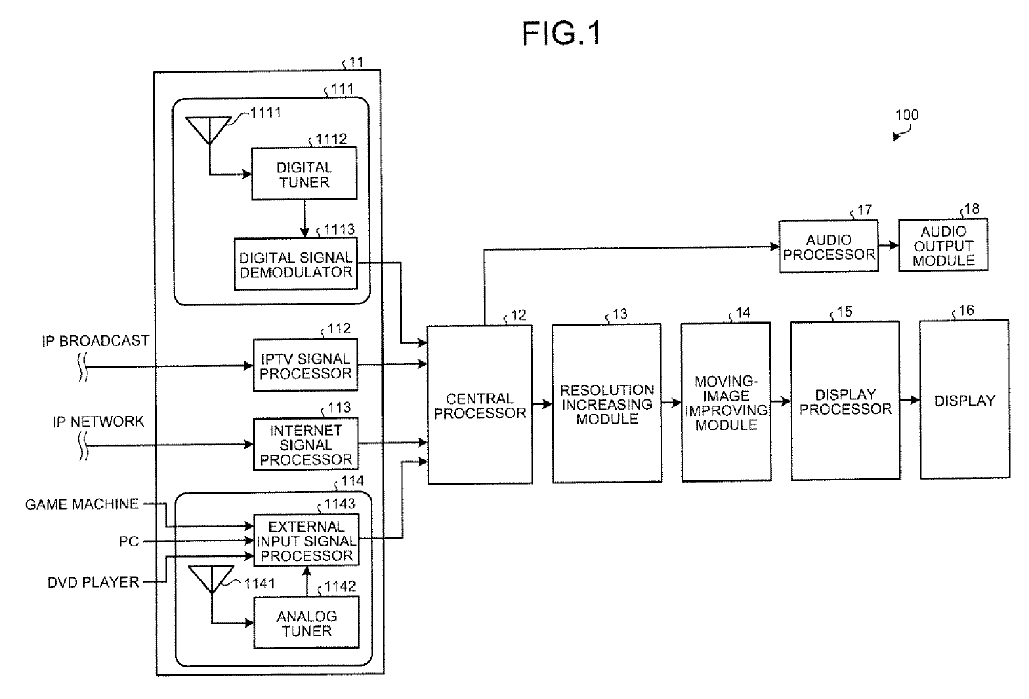

FIG. 1 is a schematic block diagram of an image display apparatus 100 according to a first embodiment. As illustrated in FIG. 1, the image display apparatus 100 includes a video signal input module 11, a central processor 12, a resolution increasing module 13, a moving-image improving module 14, a display processor 15, a display 16, an audio processor 17, and an audio output module 18. The resolution increasing module 13 corresponds to an image processor.

The video signal input module 11 includes a digital broadcast receiver 111, an Internet protocol television (IPTV) signal processor 112, an Internet signal processor 113, and an external input module 114. The video signal input module 11 receives a video signal to be displayed. The Internet signal processor 113 receives data transmitted through an IP network such as the Internet. The external input module 114 receives an analog signal. The term “video signal” as used herein includes an audio signal as well as an image signal such as still an image signal and a moving image signal.

The digital broadcast receiver 111 includes a digital antenna 1111, a digital tuner 1112, and a digital signal demodulator 1113. The digital antenna 1111 receives digital broadcasting such as BS broadcasting, CS broadcasting, and terrestrial broadcasting. The digital tuner 1112 selects a digital broadcast channel. The digital signal demodulator 1113 demodulates digital broadcasting, and outputs it to the central processor 12 as a digital video signal.

The IPTV signal processor 112 receives IP broadcasting transmitted over a dedicated IP network, and outputs it to the central processor 12 as a digital video signal.

The Internet signal processor 113 receives data (still image, moving image, etc.) transmitted through an IP network such as the Internet, and outputs it to the central processor 12 as a digital video signal.

The external input module 114 includes an analog antenna 1141, an analog tuner 1142, and an external input signal processor 1143. The analog antenna 1141 receives analog broadcasting. The analog tuner 1142 selects an analog broadcast channel. The external input signal processor 1143 performs signal processing, such as A/D conversion, on an analog signal, and outputs it to the central processor 12 as a digital video signal. The external input signal processor 1143 is provided with a terminal (not shown) for connection to an external device such as a game machine, a personal computer (PC), and a digital versatile disk (DVD) player. The external input signal processor 1143 performs the signal processing also on an analog signal received from an external device through the terminal.

The central processor 12 separates the video signal received from the video signal input module 11 into an image signal and an audio signal. Then, the central processor 12 performs predetermined signal processing on the video signal, and outputs it to the resolution increasing module 13. The signal processing performed by the central processor 12 includes, for example, format conversion and scaling processing. The format conversion converts format of the input video signal to a predetermined format (for example, MPEG (Moving Picture Experts Group)). The scaling processing converts resolution of the input video signal to a predetermined resolution (for example, 1280×720).

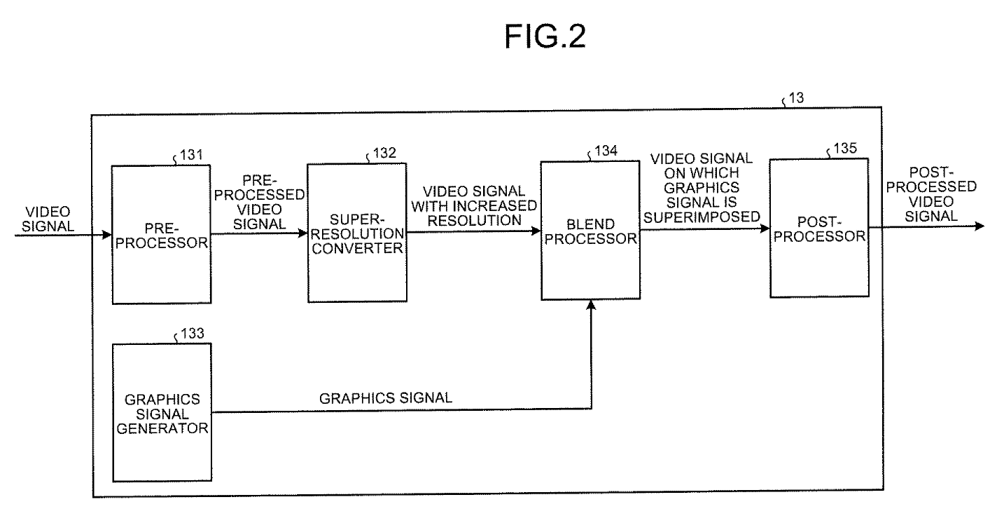

FIG. 2 is a block diagram of a detailed configuration of the resolution increasing module 13. As illustrated in FIG. 2, the resolution increasing module 13 includes a preprocessor 131, a super-resolution converter 132, a graphics signal generator 133, a blend processor 134, and a post-processor 135.

The preprocessor 131 performs pre-processing such as IP (Interlaced to progressive) conversion and NR (noise reduction) processing on the video signal received from the central processor 12, and outputs it to the super-resolution converter 132. Here, the NR processing removes noise contained in the video signal.

In the IP conversion, for example, a motion of an image contained in the video signal is detected so as to determine whether the video signal represents a still image or a moving image. Then, still image interpolation is performed on the video signal when the video signal is determined to represent a still image. On the other hand, moving image interpolation is performed on the video signal when the video signal is determined to represent a moving image. The NR processing includes, for example, correction of an image outline, a reduction of an image blur and glare, correction to suppress too much equalization (emphasis on high frequencies), and correction of camera shake caused when a camera is moved in a horizontal direction.

The super-resolution converter 132 performs image processing (hereinafter, “super resolution conversion”) on a video signal received from the preprocessor 131 to increase the resolution, and outputs it to the blend processor 134 at later stage.

The term “super resolution conversion” as used herein refers to image processing, in which, from a video signal with low resolution, i.e., first resolution, an original pixel value is estimated to increase the pixels and thus to restore an video signal with high resolution, i.e., second resolution. The original pixel value refers to the value of each pixel of a video signal obtained by, for example, photographing the same object as that of the video signal with low resolution (first resolution) with a camera having high-resolution pixels and capable of capturing a video signal with high resolution (second resolution) Besides, “original pixel value is estimated to increase the pixels” means to obtain the characteristics of images to find a correlated image, and estimate an original pixel value from neighboring images (in the same frame or between frames) using the correlated image to increase the pixels.

The super resolution conversion may be performed using known or commonly used technologies as disclosed in, for example, Japanese Patent Application Publication (KOKAI) Nos. 2007-310837, 2008-98803, and 2000-188680. In the embodiment, the super resolution conversion uses a technology of, for example, restoring an image with frequency components above the Nyquist frequency determined by the sampling rate of an input image.

If employing the super resolution conversion disclosed in Japanese Patent Application Publication (KOKAI) No. 2007-310837, the super-resolution converter 132 sets a target pixel in each of a plurality of video signals of low resolution (low-resolution frames), and sets a target image area so that it contains the target pixel. The super-resolution converter 132 selects a plurality of correspondent points that correspond to a plurality of target image areas closest to a variation pattern of the pixel value in the target image area from the reference frame. The super-resolution converter 132 sets a sample value of luminance of a correspondent point to the pixel value of a corresponding target pixel. The super-resolution converter 132 calculates a pixel value for a high-resolution frame having more pixels than the reference frame and corresponding to the reference frame based on the size of a plurality of sample values and layout of the correspondent points. Thus, the super-resolution converter 132 estimates an original pixel value from a low-resolution video signal, and increases the pixels to restore a high-resolution video signal.

If employing the super resolution conversion using self-congruency position search in the same frame image disclosed in Japanese Patent Application Publication (KOKAI) No. 2008-98803, the super-resolution converter 132 calculates a first pixel position with the smallest error, i.e., a first error, by comparing errors of respective pixels in a search area of a frame of low resolution. The super-resolution converter 132 calculates a position with the smallest error in the search area with decimal precision based on the first pixel position and the first error, and a second pixel position around a first pixel and a second error thereof. The super-resolution converter 132 calculates a decimal-precision vector that has its end point at the position with the smallest error and its start point at a pixel of interest. The super-resolution converter 132 calculates an extrapolation vector of the decimal-precision vector that has its end point at a pixel on a screen which is not in the search area based on the decimal-precision vector. The super-resolution converter 132 calculates a pixel value for a high-resolution image having more pixels than an image signal based on a pixel value obtained from the image signal, the decimal-precision vector, and the extrapolation vector. In this manner, the super-resolution converter 132 estimates an original pixel value from a low-resolution video signal, and increases the pixels to restore a high-resolution video signal.

The super-resolution converter 132 may employ the super resolution conversion disclosed in Japanese Patent Application Publication (KOKAI) No. 2000-188680 using mapping between a plurality of frames.

The above technologies of the super resolution conversion are cited by way of example and not by way of limitation. The super-resolution converter 132 may employ various other technologies in which an original pixel value is estimated from a low-resolution video signal to increase the pixels to thereby obtain a high-resolution video signal.

The graphics signal generator 133 generates a graphics signal to display a configuration screen for the image display apparatus 100 and text for presenting information, in response to a command received from an input device such as an operation button and a remote controller (not shown). Then, the graphics signal generator 133 outputs the generated graphics signal to the blend processor 134.

The graphics signal generator 133 generates the graphics signal in a format that is the same as that of the video signal output from the super-resolution converter 132. For example, the graphics signal generator 133 generates a graphics signal in YCbCr format when the video signal from the super-resolution converter 132 is in YCbCr format. Here, the video signal in the YCbCr format is separated into a luminance signal (Y signal) and a color difference signal (C signal). Furthermore, the graphics signal generator 133 generates a graphics signal in RGB format when the video signal from the super-resolution converter 132 is in RGB format.

The blend processor 134 superimposes the graphics signal received form the graphics signal generator 133 on the video signal received from the super-resolution converter 132. Then, the blend processor 134 outputs the superimposed signal to the post-processor 135. When the graphics signal is not received from the graphics signal generator 133, the blend processor 134 outputs the video signal received from the super-resolution converter 132 to the post-processor 135 without the superimposition of the signal.

The post-processor 135 performs image correction such as gamma correction on the video signal on which the graphics signal is superimposed by the blend processor 134. Then, the post-processor 135 outputs the signal to the following moving-image improving module 14.

As mentioned above, the resolution increasing module 13 superimposes the graphics signal on the video signal on which the super resolution processing is performed by the super-resolution converter 132. Accordingly, load on the processing of the super-resolution converter 132 can be suppressed, an amount of memory (not shown) in use used as a buffer of the processing can be decreased, and run speed can be improved. Hence, processing can effectively be performed.

Back to FIG. 1, the moving-image improving module 14 generates an intermediate frame from the video signal received from the resolution increasing module 13. Accordingly, the moving-image improving module 14 increases the number of frames per second of the video signal to a predetermined value. Then, the moving-image improving module 14 outputs the signal to the display processor 15 at later stage. For example, assume that the video signal received from the resolution increasing module 13 corresponds to 60 frames per second. Then, the moving-image improving module 14 generates the intermediate frame from each image of the 60 frames so as to generate a video signal corresponding to 120 frames per second. Then, the moving-image improving module outputs the signal to the display processor 15.

The display processor 15 includes a display driver configured to control displaying a video signal received from the moving-image improving module 14 on the display 16. The display 16 includes a display device such as a liquid crystal display (LCD) panel, a plasma panel, or a surface-conduction electron-emitter display (SED) panel. The display 16 displays a video signal thereon under the control of the display processor 15.

The audio processor 17 converts a digital audio signal received from the central processor 12 to an analog audio signal in a format playable by the audio output module 18. Then, the audio processor 17 outputs it to the audio output module 18. The audio output module 18 includes a speaker and the like, and outputs as an audio the analog audio signal received from the audio processor 17.

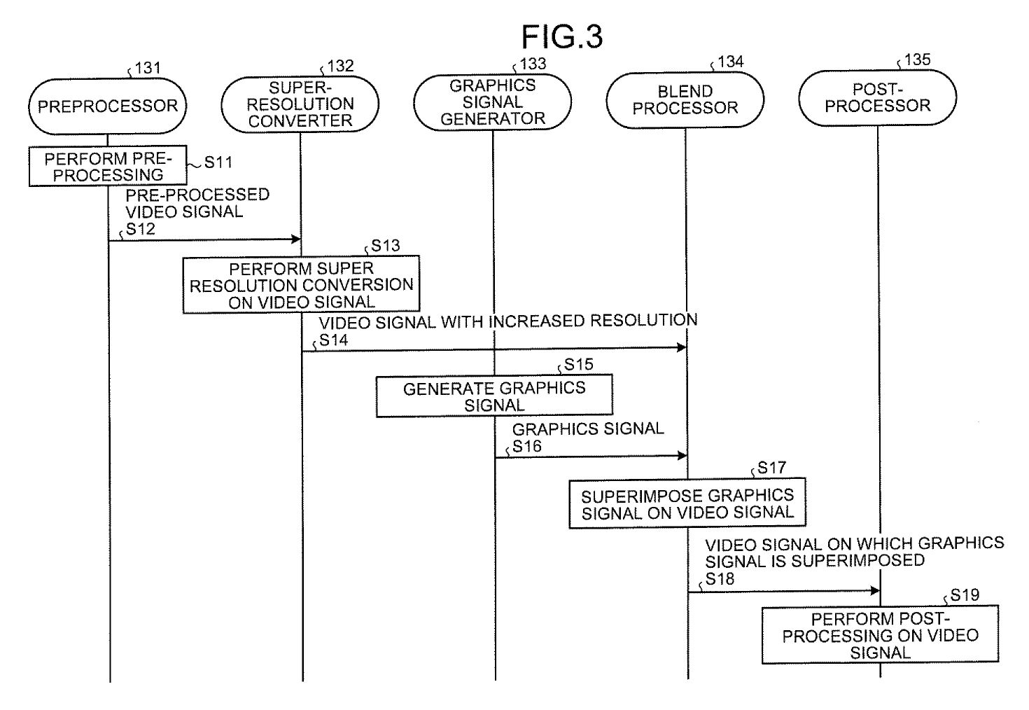

Described below is the operation of the resolution increasing module 13. FIG. 3 is a sequence diagram of the resolution increasing processing of the resolution increasing module 13. In the processing, it is assumed that a configuration screen of the image display apparatus 100 is commanded to be displayed, by the operation button, the remote controller, or the like (not shown).

When the resolution increasing module 13 receives the video signal from the central processor 12, the preprocessor 131 performs the aforementioned pre-processing on the received video signal (S11). Then, the preprocessor 131 outputs the video signal on which the pre-processing is performed to the super-resolution converter 132 (S12).

Upon receipt of the video signal from the preprocessor 131, the super-resolution converter 132 increases the resolution of the video signal by performing the aforementioned super resolution conversion on the video signal (S13). Then, the super-resolution converter 132 outputs the video signal on which the super resolution conversion is performed to the blend processor 134 (S14).

The graphics signal generator 133 generates the graphics signal for displaying the configuration screen of the image display apparatus 100 (S15). Then, the graphics signal generator 133 outputs the graphics signal to the blend processor 134 (S16).

The blend processor 134 superimposes the graphics signal received from the graphics signal generator 133 on the video signal received from the super-resolution converter 132, and synthesizes an image corresponding to the graphics signal with a screen corresponding to the video signal (S17). Then, the blend processor 134 outputs the video signal on which the graphics signal is superimposed to the post-processor 135 (S18).

Upon receipt of the video signal (on which the graphics signal is superimposed), the post-processor 135 performs the aforementioned post-processing on the video signal (S19), and outputs the resultant video signal of the processing to the moving-image improving module 14. Accordingly, the present processing ends.

As mentioned above, according to the first embodiment, the blend processor 134 is provided at the later stage of the super-resolution converter 132. Accordingly, the graphics signal generated by the graphics signal generator 133 can be superimposed on the video signal processed by the super-resolution converter 132. As a result, the superimposition of the graphics signal and the video signal having resolution increased by the super resolution conversion can be performed while the quality of the video is maintained.

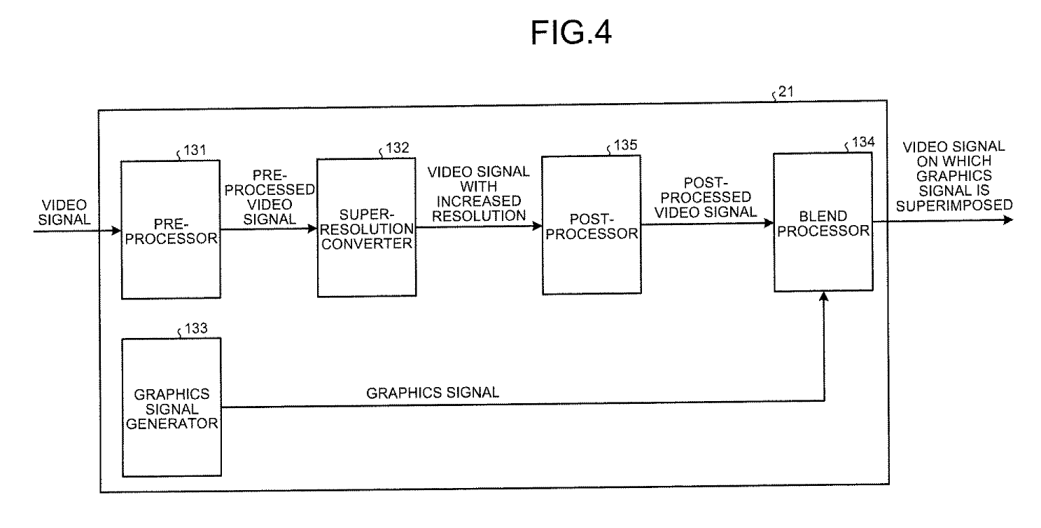

In the first embodiment, the blend processor 134 is provided at earlier stage of the post-processor 135. However, as illustrated in FIG. 4, the blend processor 134 may be provided at later stage of the post-processor 135. FIG. 4 is a block diagram of a detailed configuration of a resolution increasing module 21 which is a modification of the resolution increasing module 13. In the resolution increasing module 21, the blend processor 134 is provided at later stage of the post-processor 135.

The configuration illustrated in FIG. 4 can superimpose the graphics signal on the video signal on which the post-processing is performed by the post-processor 135. Accordingly, it can be avoided to perform the post-processing on the graphics signal, so that the processing in the resolution increasing module 13 can effectively be performed. Here, the graphics signal generator 133 generates a graphics signal in format which is identical to that of the video signal output from the post-processor 135.

Furthermore, in terms of recording the video signal on which the super resolution conversion is performed by the super-resolution converter 132 in a recording medium such as DVD, a video signal on which the super resolution conversion is already performed and the graphics signal is not superimposed can be saved in a recording medium by performing the super resolution conversion prior to superimposition of the graphics signal.

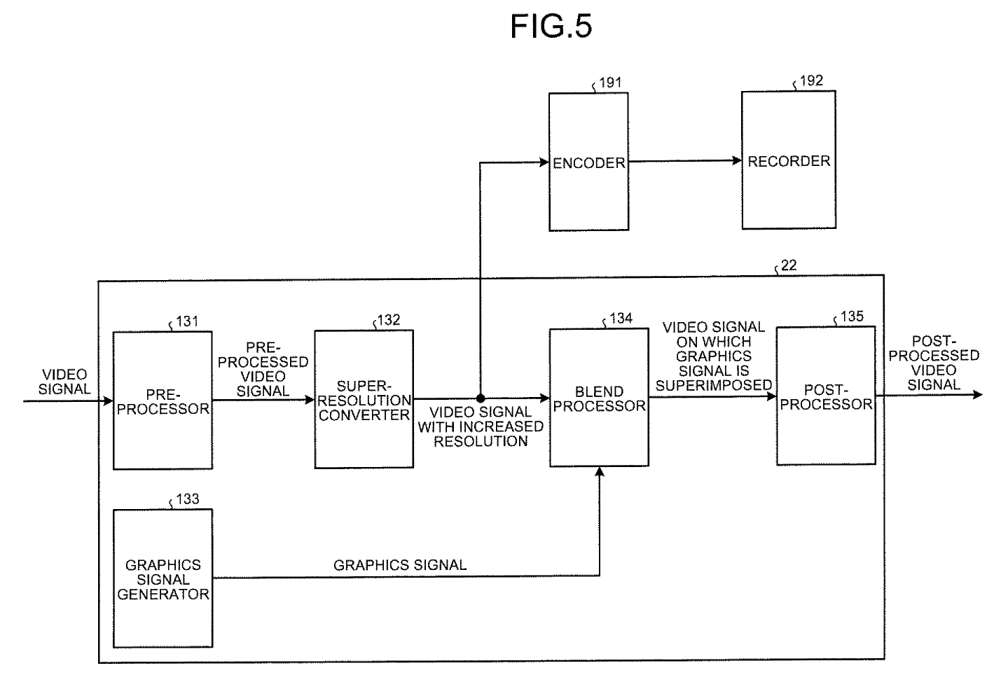

In particular, as illustrated in FIG. 5, a resolution increasing module 22 can be configured so that the output from the super-resolution converter 132 is to be input to an encoder 191 and the output from the encoder 191 is to be recorded in a recorder 192. Accordingly, the video signal on which the super resolution conversion is already performed can be saved in the recording medium. Here, FIG. 5 is a block diagram of a detailed configuration of the resolution increasing module 22 which is a modification of the resolution increasing module 13.

The encoder 191 converts (encodes) the video signal received from the super-resolution converter 132 to a video signal in a predetermined image compression format such as H.264. Then, the encoder 191 outputs it to the recorder 192. The recorder 192 is a recording device configured to record data in a recording medium such as DVD-R (Digital Versatile Disc-Recordable). The recorder 192 records the encoded video signal received from the encoder 191 on the recording medium.

Accordingly, the video signal on which the graphics signal is not superimposed and having increased resolution can be output to the encoder 191 and the recorder 192. Hence, only the video signal having increased resolution can be recorded in the recording medium such as DVD-R.

In the aforementioned embodiment, the image processor is applied to an image display device which is configured to display a video signal; however, the image processor is not limited thereby. That is to say, the image processor can be applied to a digital camera, a video camera, an image player playing still image and moving image, and the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An image processor comprising:
a super-resolution converter configured to perform, on receipt of a first video signal with first resolution, super resolution conversion on the first video signal to restore a second video signal with second resolution that is higher than the first resolution by estimating an original pixel value from the first video signal and increasing pixels;
a graphics signal generator configured to generate a graphics signal of a predetermined image; and
a blend processor provided at later stage of the super-resolution converter, and configured to superimpose the graphics signal on the second video signal.

2. The image processor of claim 1, wherein the second video signal and the graphics signal are each input to the blend processor through a different passage.

3. The image processor of claim 1, further comprising a preprocessor configured to perform predetermined image processing on the first video signal, prior to the super resolution conversion.

4. The image processor of claim 1, further comprising a post-processor provided at later stage of the blend processor, and configured to perform predetermined image processing on the second video signal on which the graphics signal is superimposed.

5. The image processor of claim 1, further comprising a post-processor provided between the super-resolution converter and the blend processor, and configured to perform predetermined image processing on the second video signal.

6. The image processor of claim 1, further comprising an encoder configured to convert the second video signal to a video signal in predetermined moving-image format, the encoder receiving the second video signal from the super-resolution converter through a connection line connected to a passage between the super-resolution converter and the blend processor.

7. The image processor of claim 6, further comprising a recorder configured to record on a recording medium the video signal in the moving-image format.

8. An image processor comprising:
a super-resolution converter configured to perform super resolution conversion on a first video signal with first resolution to obtain a second video signal with second resolution that is higher than the first resolution using super resolution technology;
a graphics signal generator configured to generate a graphics signal of a predetermined image; and
a blend processor provided at later stage of the super-resolution converter, and configured to superimpose the graphics signal on the second video signal.

9. An image processing method comprising:
performing, on receipt of a first video signal with first resolution, super resolution conversion on the first video signal to restore a second video signal with second resolution that is higher than the first resolution by estimating an original pixel value from the first video signal and increasing pixels;
generating a graphics signal of a predetermined image; and
superimposing the graphics signal on the second video signal.
